(19) United States
(12) Patent Application Publication
(10) Pub. No.: US 2026/0034604 A1
(43) Pub. Date: Feb. 5, 2026

(54) HOLLOW METAL MEMBER MANUFACTURING METHOD, HOLLOW METAL MEMBER, AND ROTATION TOOL

(71) Applicant: AISIN CORPORATION, Kariya-shi (JP)

(72) Inventors: Takahiro IMAI, Kariya-shi (JP); Takeshi MATSUO, Kariya-shi (JP); Kentaro NIWA, Kariya-shi (JP)

(73) Assignee: AISIN CORPORATION, Kariya-shi (JP)

(21) Appl. No.: 19/256,916

(22) Filed: Jul. 1, 2025

(30) Foreign Application Priority Data
Jul. 31, 2024 (JP) 2024-124771
Jan. 29, 2025 (JP) 2025-013217
Mar. 27, 2025 (JP) 2025-053742

(51) Int. Cl. B23K 20/12

(52) U.S. Cl. CPC B23K 20/1255

(57) ABSTRACT

A hollow metal member manufacturing method for manufacturing a hollow metal member, which is a metal member having an internal space, by using a rotation tool, includes: a step of preparing a recessed metal member in which a recessed portion corresponding to a desired internal space shape is formed from a surface to an inside of the metal member; and a step of moving the rotation tool along an opening of the recessed portion while pressing the rotation tool against an opening surface, which is a surface of the recessed metal member on which the recessed portion is formed, and closing the recessed portion with a softened material of the opening surface.

### CROSS REFERENCE TO RELATED APPLICATIONS

This application is based on and claims priority under 35 U.S.C. § 119 to Japanese Patent Applications 2024-124771, filed on Jul. 31, 2024, 2025-013217, filed on Jan. 29, 2025, 2025-053742, filed on Mar. 27, 2025, the entire content of which is incorporated herein by reference.

### TECHNICAL FIELD

This disclosure relates to a hollow metal member manufacturing method.

### BACKGROUND DISCUSSION

For example, in order to form a member having therein a space through which a liquid or a gas passes, a hollow metal member that is a metal member having an internal space may be manufactured. As the hollow metal member manufacturing method, a method using a friction stir processing (FSP) is known.

An example of the hollow metal member manufacturing method using the friction stir processing (FSP) is disclosed in JP 2014-223680A (Reference 1). In the method of JP 2014-223680A (Reference 1), by using a rotation tool, the rotation tool is moved while being rotated along a surface of a metal member, a shallow groove portion is formed, and at the same time, the groove portion is covered by a lid to form a tunnel-like internal space inside the metal member.

However, the method of Reference 1 has a problem that a shape of the internal space formed inside the hollow metal member is restricted by a shape of the rotation tool.

A need thus exists for a hollow metal member manufacturing method which is not susceptible to the drawback mentioned above.

### SUMMARY

A hollow metal member manufacturing method according to the disclosure for manufacturing a hollow metal member, which is a metal member having an internal space, by using a rotation tool, includes: a step of preparing a recessed metal member in which a recessed portion corresponding to a desired internal space shape is formed from a surface to an inside of the metal member; and a step of moving the rotation tool along an opening of the recessed portion while pressing the rotation tool against an opening surface, which is a surface of the recessed metal member on which the recessed portion is formed, and closing the recessed portion with a softened material of the opening surface.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view of a hollow metal member according to a first embodiment;

FIG. 2 is a perspective view of a grooved metal member;

FIG. 3 is a cross-sectional view showing one aspect of a closing step;

FIG. 4 is a plan view showing one aspect of the closing step;

FIG. 5 shows an offset width of a rotation tool with respect to a groove portion;

FIG. 6 is a plan view of the hollow metal member;

FIG. 7 is a cross-sectional view taken along a line VII-VII in FIG. 6;

FIG. 8 is a cross-sectional view taken along a line VIII-VIII in FIG. 6;

FIG. 9 is a plan view of a holed metal member according to a second embodiment;

FIG. 10 is a cross-sectional view of the holed metal member;

FIG. 11 is a plan view showing one aspect of a closing step;

FIG. 12 shows an offset width of a rotation tool with respect to a hole portion;

FIG. 13 is a plan view of a hollow metal member;

FIG. 14 is a schematic front view of a fixed tool used in a third embodiment;

FIG. 15 is a partial enlarged view of FIG. 14;

FIG. 16 is a schematic bottom view of the fixed tool;

FIG. 17 is a cross-sectional view showing one aspect of a closing step;

FIG. 18 is a plan view showing one aspect of the closing step;

FIG. 19 is a perspective view of a hollow metal member;

FIG. 20 is a cross-sectional view of the hollow metal member; and

FIG. 21 is a photograph showing a state of a closing portion viewed from an internal space side.

### DETAILED DESCRIPTION

### First Embodiment

A hollow metal member 1 and a manufacturing method thereof (hollow metal member manufacturing method) according to a first embodiment will be described with reference to the drawings.

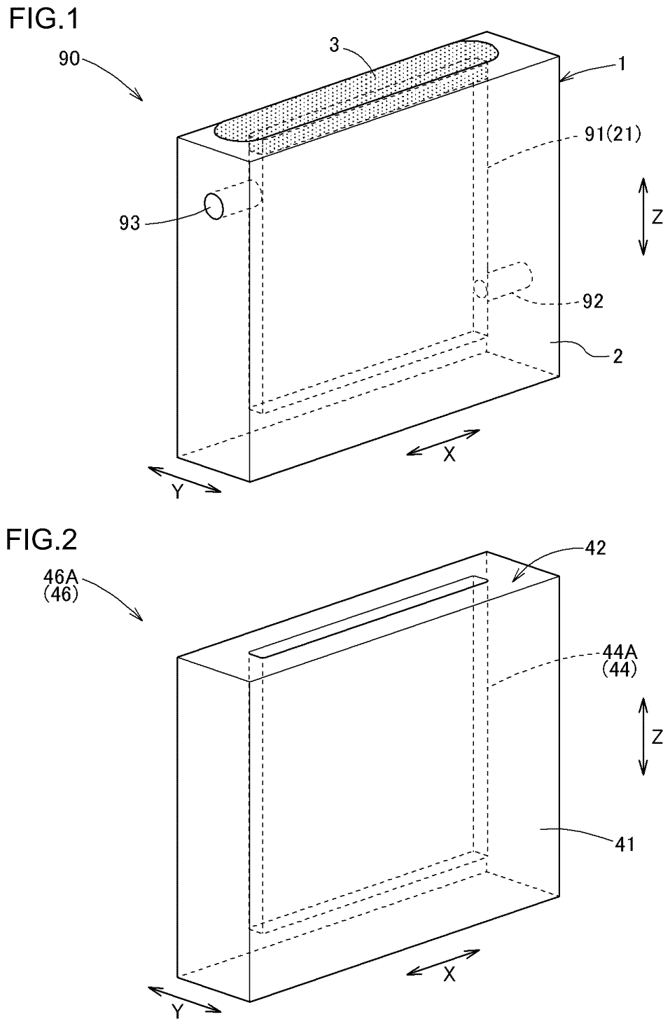

The hollow metal member 1 according to the embodiment is a part of a cooling member 90 constituting a cooling device together with, for example, a refrigerant circuit and a pump. The cooling member 90 is formed in a lump shape using a metal material, and as shown in FIG. 1, includes a flow path space 91 in which a refrigerant flows, and an inflow port 92 and an outflow port 93 that communicate the flow path space 91 with the outside. The refrigerant circuit is connected to the inflow port 92 and the outflow port 93 directly or indirectly via a connection member or the like.

The hollow metal member 1 is used as a member to be the source of the cooling member 90. The hollow metal member 1 is a metal member having an internal space 21. The hollow metal member 1 includes a body portion 2 and a closing portion 3 formed in a portion on a surface side of the body portion 2. In the embodiment, the body portion 2 is formed in a flat rectangular parallelepiped shape. The internal space 21 is formed inside the body portion 2. In the example, the internal space 21 is formed not in a simple linear shape but in a two-dimensional manner. The closing portion 3 closes the internal space 21 at a portion on the surface side of the body portion 2. Thus, the hollow metal member 1 according to the embodiment has the sealed internal space 21.

Through-holes communicating with the internal space 21 are formed from two opposing side surfaces of the hollow metal member 1, respectively, to form the cooling member 90. In this case, the two through-holes serve as the inflow port 92 and the outflow port 93, and the internal space 21 serves as the flow path space 91.

In the following description, a height direction of the hollow metal member 1 in FIG. 1 is referred to as a Z direction, a longitudinal direction of the hollow metal member 1 viewed from the Z direction is referred to as an X direction, and a lateral direction is referred to as a Y direction. The internal space 21 of the hollow metal member 1 according to the embodiment is a space extending in each of the X direction and the Z direction.

In the hollow metal member manufacturing method according to the embodiment, the hollow metal member 1 is manufactured using a friction stir processing (FSP). That is, in the hollow metal member manufacturing method according to the embodiment, the hollow metal member 1 is manufactured through a step of stirring a material softened by friction heat by plastic flow using a rotation tool 6 rotating at a high speed.

The hollow metal member manufacturing method includes a step of preparing a recessed metal member 46 (hereinafter referred to as “preparation step”) and a step of closing a recessed portion 44 formed in the recessed metal member 46 (hereinafter referred to as “closing step”).

In the preparation step, the recessed metal member 46, in which the recessed portion 44 is formed from a surface to an inside of a metal member 41, is prepared. The recessed portion 44 is a portion recessed from the surface toward the inside of the metal member 41, and may be closed or opened on the opposite side regardless of the depth. In the embodiment, in the preparation step, as shown in FIG. 2, a grooved metal member 46A, in which a groove portion 44A extending in the longitudinal direction at a predetermined depth is formed from the surface to the inside of the metal member 41, is prepared.

A metal material constituting the metal member 41 is not particularly limited as long as it is a metal that can be frictionally stirred, and for example, aluminum, copper, titanium, magnesium, and an alloy thereof can be used. When used as a part of the cooling member 90 as in the embodiment, a metal having high thermal conductivity (for example, copper or aluminum) is preferable.

The grooved metal member 46A as the recessed metal member 46 may be formed by, for example, casting. In this case, the grooved metal member 46A is formed as the metal member 41 in which the groove portion 44A as the recessed portion 44 is formed from the beginning. The grooved metal member 46A may be formed by, for example, cutting the metal member 41 as a base body. In this case, the grooved metal member 46A is formed by forming the groove portion 44A in the metal member 41 later. In either case, the grooved metal member 46A having the groove portion 44A having various shapes can be formed by adjusting a mold shape or a processing shape.

The shape of the groove portion 44A of the grooved metal member 46A is determined according to a shape of the internal space 21 of the hollow metal member 1 to be finally obtained. That is, the shape of the groove portion 44A is determined to include the shape of the desired internal space 21 and to be a shape extending in at least one direction to open to the surface of the metal member 41. In the embodiment, the surface in which the groove portion 44A is open is referred to as an opening surface 42. In the example shown in FIG. 2, the grooved metal member 46A has the groove portion 44A having the same shape as the desired internal space 21 and having a shape extending in the Z direction until reaching the opening surface 42.

That is, the groove portion 44A of the grooved metal member 46A is formed to have the same size as the internal space 21 of the hollow metal member 1 to be finally obtained in the X direction and the Y direction, have a size larger than the internal space 21 in the Z direction, and open to the surface. With reference to the groove portion 44A of the grooved metal member 46A, a depth direction of the groove portion 44A is the Z direction, an extending direction is the X direction, and a width direction is the Y direction.

A body for forming the grooved metal member 46A may be the same as or different from a manufacturing body of the hollow metal member 1. That is, in the preparation step, the manufacturing body of the hollow metal member 1 may be prepared by forming the grooved metal member 46A by itself, or may be prepared by procuring the grooved metal member 46A formed by another body.

In the closing step, the groove portion 44A is closed by the friction stir processing (FSP) for the grooved metal member 46A. The friction stir processing (FSP) is executed using a friction stir device including the rotation tool 6, a drive unit that rotates the rotation tool 6, and a pressing unit that applies a pressing force to the rotation tool 6 along a direction of a rotation axis.

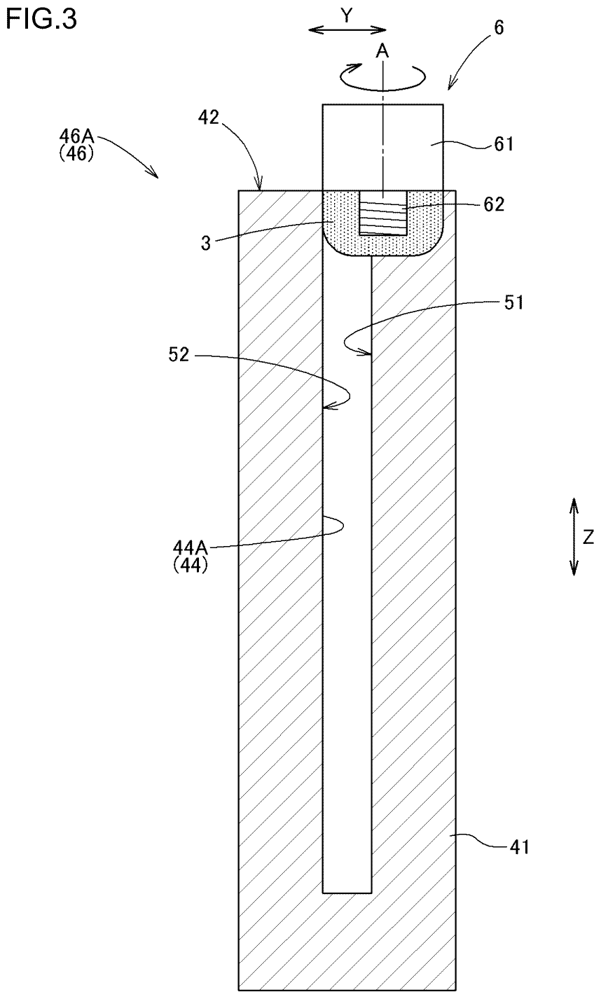

In the embodiment, as the rotation tool 6, a tool of a normal specification generally used for the friction stir processing (FSP) is used. As shown in FIG. 3, the rotation tool 6 includes a shoulder 61 and a probe 62 provided integrally with the shoulder 61. The shoulder 61 is formed in a columnar shape rotatable around a rotation axis A. The shoulder 61 is drivingly connected to the drive unit and rotates around the rotation axis A by a power from the drive unit. The shoulder 61 is also drivingly connected to the pressing unit, and can advance and retreat along the rotation axis A.

The probe 62 is provided coaxially with the shoulder 61 to protrude further downward from a lower surface of the shoulder 61. The probe 62 is formed in a columnar shape having a substantially constant diameter. The probe 62 is formed to have a diameter smaller than the shoulder 61. The probe 62 rotates around the rotation axis A together with the shoulder 61 by the power from the drive unit. The probe 62 is also drivingly connected to the pressing unit, and can advance and retreat along the rotation axis A together with the shoulder 61.

The rotation tool 6 is made of a high hardness material such as high-speed tool steel, alloy tool steel, super steel alloy, and ceramics.

In the closing step, first, as shown in FIG. 3, the rotation tool 6 is pressed against a position adjacent to the groove portion 44A of the opening surface 42 of the grooved metal member 46A while being rotated at a high speed. In the embodiment, the rotation tool 6 is pressed against a position (offset position) of the opening surface 42 of the grooved metal member 46A adjacent to the groove portion 44A in the Y direction, which is the width direction of the groove portion 44A. Then, the metal material constituting the grooved metal member 46A is locally heated and softened by the friction heat, and the probe 62 enters an inside of the grooved metal member 46A. At this time, the probe 62 enters the inside of the grooved metal member 46A until the lower surface of the shoulder 61 comes into contact with the opening surface 42 of the grooved metal member 46A.

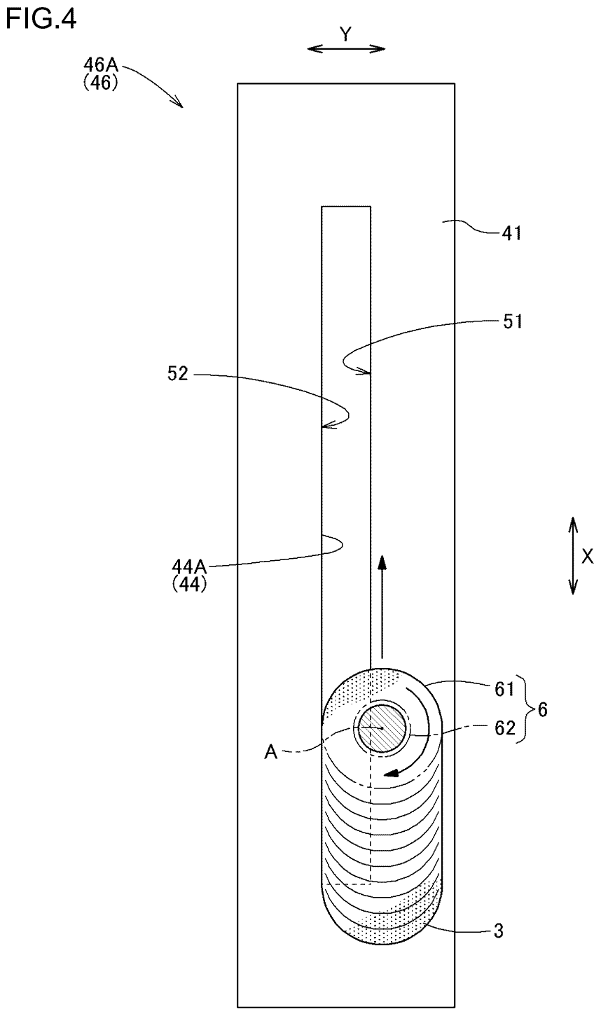

Next, while maintaining this state, as shown in FIG. 4, the rotation tool 6 is relatively moved along the position adjacent to the groove portion 44A of the opening surface 42 of the grooved metal member 46A. That is, in a state where the probe 62 enters the inside of the grooved metal member 46A until the lower surface of the shoulder 61 comes into contact with the opening surface 42, the rotation tool 6 is relatively moved along the position adjacent to the groove portion 44A of the opening surface 42 of the grooved metal member 46A while being rotated at a high speed. In the embodiment, at the position on the opening surface 42 of the grooved metal member 46A adjacent to the groove portion 44A in the Y direction, the rotation tool 6 is relatively moved along the X direction, which is the extending direction of the groove portion 44A. Then, the metal material constituting the grooved metal member 46A flows to the opening surface 42 side of the groove portion 44A while being sequentially softened by the friction heat, and the groove portion 44A is closed by the softened material.

As described above, in the closing step, the rotation tool 6 is moved (relatively moved) on a trace parallel to an opening edge of the groove portion 44A while being pressed against the opening surface 42 of the grooved metal member 46A. Specifically, the rotation axis A of the rotation tool 6 is moved on the trace. The trace described above is a trace offset in the width direction of the groove portion 44A with respect to the groove portion 44A (specifically, a center of the groove portion 44A in the width direction), and in other words, is a linear trace parallel to the opening edge of the groove portion 44A along the X direction. In the closing step, the rotation tool 6 is linearly moved along the opening edge of the groove portion 44A along the X direction. As is clear from the above description, moving along the opening edge is a concept including moving along a position offset from the opening edge. In the closing step, the groove portion 44A is closed by the softened material of the opening surface 42.

The flow of the softened metal material is a plastic flow while maintaining a solid phase, and a softened metal that has reached a region of the groove portion 44A on the opening surface 42 side, which is a portion positioned in the vicinity of the probe 62, remains at the position as it is (that is, does not flow down to a bottom side of the groove portion 44A). Therefore, the groove portion 44A can be appropriately closed with the softened material.

The relative movement of the rotation tool 6 may be performed by moving the rotation tool 6 in a state where the grooved metal member 46A as a workpiece is held on a fixed table, or may be performed by moving the grooved metal member 46A held on a movable table in a state where the rotation tool 6 is held at a predetermined position. Alternatively, the rotation tool 6 may be relatively moved by moving both the rotation tool 6 and the grooved metal member 46A. An aspect to be adopted may be selected according to a specification of the friction stir device to be used.

Processing conditions in the closing step are not particularly limited, but are preferably determined as appropriate according to materials, sizes, or the like of the rotation tool 6 and the grooved metal member 46A as the workpiece. A rotation speed of the rotation tool 6 may be, for example, 1000 rpm to 5000 rpm. A pressing pressure of the rotation tool 6 against the grooved metal member 46A may be, for example, 10 MPa to 20 MPa. A relative movement speed of the rotation tool 6 may be, for example, 200 mm/min to 1000 mm/min.

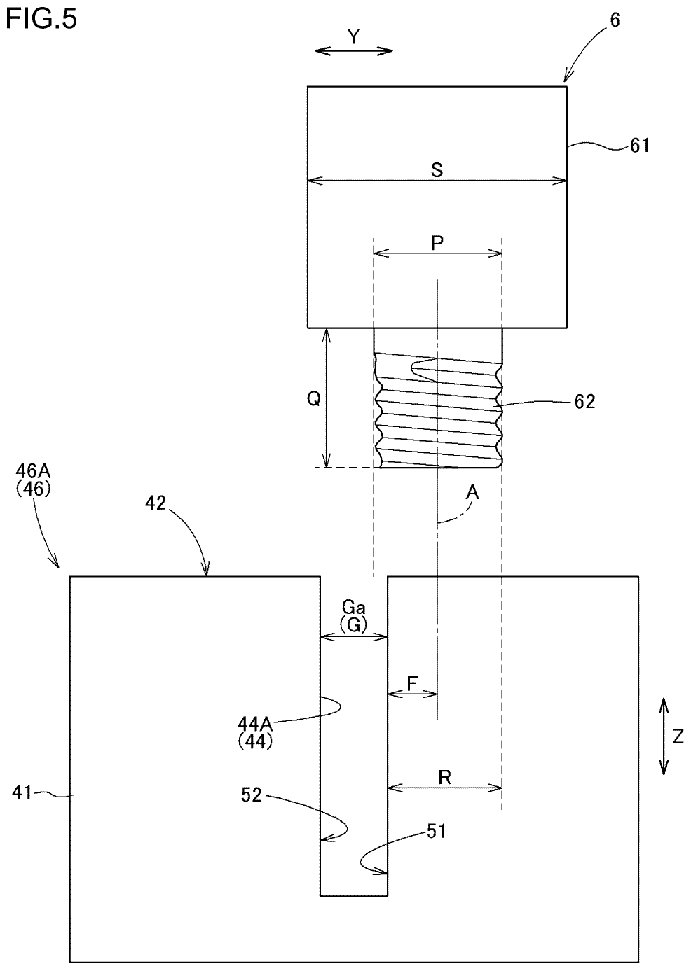

Referring to FIG. 5, the offset (that is, the trace described above) of the rotation tool 6 in the Y direction with respect to the groove portion 44A is set such that a part of the rotation tool 6 is positioned inside an opening edge of the recessed portion 44 (the groove portion 44A in the embodiment). Specifically, the offset of the rotation tool 6 in the Y direction with respect to the groove portion 44A is preferably set to satisfy the following conditions. Here, among inner surfaces of the groove portion 44A facing each other in the Y direction, which is the width direction, the inner surface on the side where the rotation tool 6 is offset is referred to as a reference inner surface 51 of the recessed portion 44, and the other inner surface (the inner surface on the side opposite to the reference inner surface 51) is referred to as a facing inner surface 52.

In FIG. 5, a diameter of the shoulder 61 of the rotation tool 6 (hereinafter referred to as “shoulder diameter”) is denoted by “S”, a diameter of the probe 62 (hereinafter referred to as “probe diameter”) is denoted by “P”, and a width of the groove portion 44A in the Y direction which is the width direction (hereinafter referred to as “groove width”) is denoted by “G”. A separation length (hereinafter, referred to as “offset width”) in the Y direction along the opening surface 42 from the reference inner surface 51 of the recessed portion 44 (groove portion 44A) to the rotation axis A of the rotation tool 6 is defined as “F”. A separation length (hereinafter, referred to as “processing margin”) in the Y direction along the opening surface 42 from the reference inner surface 51 of the groove portion 44A to a highest reaching point of the rotation tool 6 is defined as “R”.

An offset of the rotation tool 6 is preferably set such that a ratio (hereinafter referred to as “offset ratio (F/P)”) of the offset width F, from the reference inner surface 51 of the groove portion 44A to the rotation axis A of the rotation tool 6, to the probe diameter P is 0 or more and 1 or less. By setting the offset ratio (F/P) to 0 or more, an amount of the metal material softened by the friction stir processing (FSP) and flowing into the groove portion 44A can be sufficiently secured. Further, when the offset ratio (F/P) becomes excessive, the metal material softened by the friction stir processing (FSP) cannot reach the groove portion 44A, but by reducing the offset ratio to 1 or less, it is possible to secure that the softened metal material flows into the groove portion 44A.

The highest reaching point of the rotation tool 6 from the reference inner surface 51 of the groove portion 44A is a position advanced by a radius (0.5P) of the probe 62 from the rotation axis A of the rotation tool 6 in the Y direction. Therefore, when the offset ratio (F/P) is “0”, a ratio of the processing margin R to the probe diameter P (hereinafter referred to as a processing margin ratio (R/P)) is “0.5”, and when the offset ratio (F/P) is “1”, the processing margin ratio (R/P) is “1.5”. That is, a condition that “the offset ratio (F/P) is 0 or more and 1 or less” is equivalent to a condition that “the processing margin ratio (R/P) is 0.5 or more and 1.5 or less”.

In the closing step, when a pressing position of the rotation tool 6 against the opening surface 42 of the grooved metal member 46A is determined, a corresponding conditional expression may be satisfied based on the easier management of the offset width F and the processing margin R.

In addition, the offset width F is preferably set within a range in which the shoulder 61 of the rotation tool 6 covers the facing inner surface 52 of the groove portion 44A. Here, a separation length in the Y direction along the opening surface 42 from the facing inner surface 52 of the groove portion 44A to the rotation axis A of the rotation tool 6 is equal to a sum of the offset width F and the recessed portion width G. When the separation length from the facing inner surface 52 to the rotation axis A is equal to or less than a radius (0.5S) of the shoulder 61, the shoulder 61 covers the facing inner surface 52 of the groove portion 44A. Therefore, more quantitatively, the offset width F is preferably set to be equal to or less than a difference between the radius (0.5S) of the shoulder 61 and the recessed portion width G (F≤0.5S-G). In the embodiment, the recessed portion width G is a groove width Ga that is a width in the Y direction orthogonal to a movement trace of the groove portion 44A, and the offset width F is preferably set to be equal to or less than a difference between the radius (0.5S) of the shoulder 61 and the groove width Ga (F≤0.5S−Ga). Accordingly, the groove portion 44A can be closed in one pass (that is, in one process on one side in the Y direction with respect to the groove portion 44A), and the processing efficiency is high.

Of course, the offset width F may not necessarily be set such that the shoulder 61 covers the facing inner surface 52. In such a case, the groove portion 44A may be closed in two passes. That is, after the first process on one side in the Y direction with respect to the groove portion 44A, the second process may be performed on the opposite side (the other side in the Y direction) of the groove portion 44A, and the groove portion 44A may be closed by the cooperation of both. In this case, the offset width F is preferably set within a range in which the shoulder 61 of the rotation tool 6 covers a center position of the groove portion 44A in the width direction, and more quantitatively, is preferably set to be equal to or less than half a difference between the shoulder diameter S and the recessed portion width G (F≤0.5 (S−G)). In the embodiment, the offset width F is preferably set to be equal to or less than half a difference between the shoulder diameter S and the groove width Ga (F≤ 0.5(S−Ga)).

A length of the probe 62 of the rotation tool 6 (hereinafter referred to as “probe length” and denoted by “Q” in FIG. 5) is preferably set to a length that can secure sufficient strength even during processing. The probe length Q is typically set to be equal to or less than the probe diameter P.

In the embodiment, it is preferable to use the rotation tool 6 having the probe diameter P which is a length different from the recessed portion width G in relation to the recessed portion width G. In the shown example, the rotation tool 6 having the probe diameter P longer than the recessed portion width G is used. However, the disclosure is not limited to such a configuration, and the rotation tool 6 having the probe diameter P which is a length equal to or less than the recessed portion width G may be used. For example, when the groove portion 44A is closed in one pass as described above, the rotation tool 6 having the probe diameter P which is a length the same as the recessed portion width G can be used. When the groove portion 44A is closed in two passes as described above, the rotation tool 6 having the probe diameter P which is a length of about half the recessed portion width G can be used.

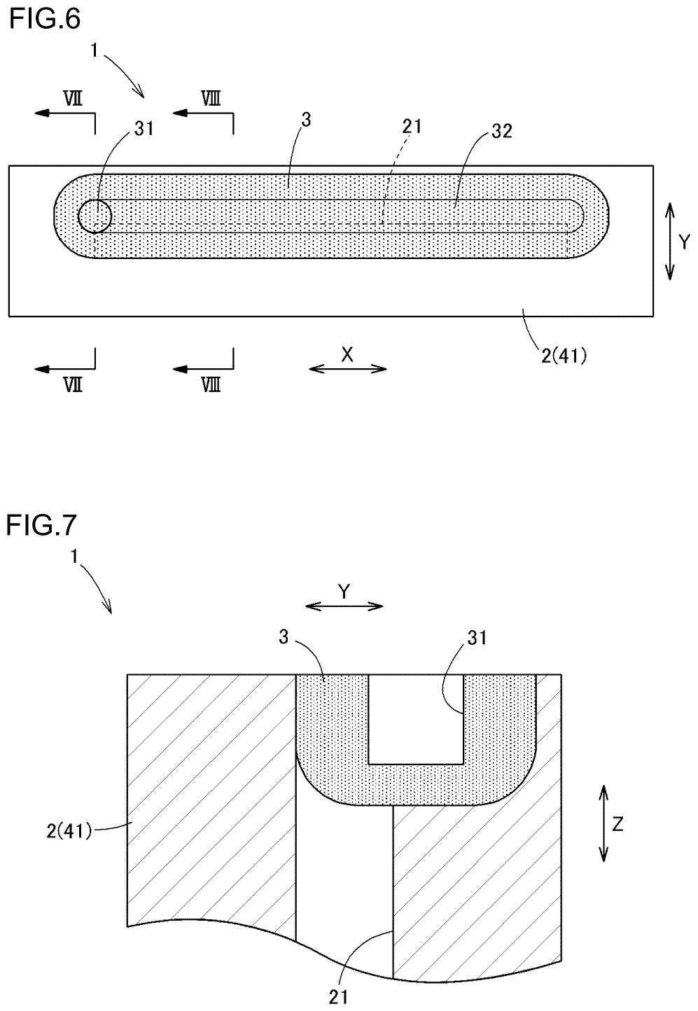

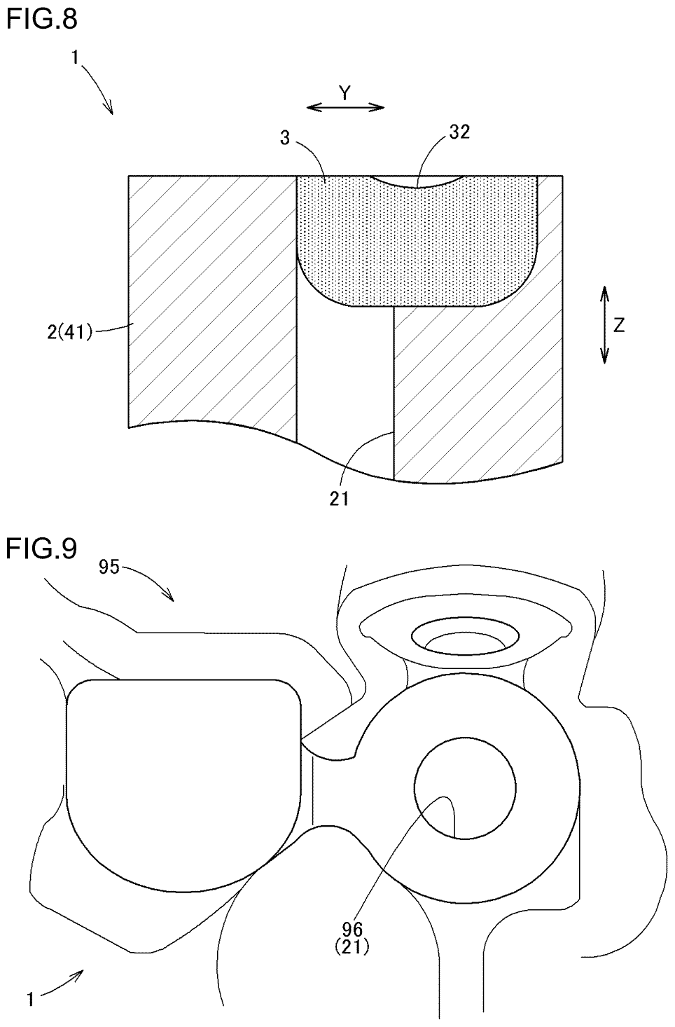

As shown in FIGS. 1 and 6 to 8, the hollow metal member 1 obtained through these steps includes the body portion 2 in which the internal space 21 is formed, and the closing portion 3 formed in a portion on the surface side of the body portion 2 with respect to the internal space 21. The body portion 2 is derived from the metal member 41 of the grooved metal member 46A. That is, the metal member 41 of the grooved metal member 46A subjected to the closing step becomes the body portion 2 of the hollow metal member 1 to be finally obtained. The internal space 21 is derived from the groove portion 44A of the grooved metal member 46A. That is, in the groove portion 44A of the grooved metal member 46A subjected to the closing step, a portion excluding a portion closed by the metal material softened and flowing in the closing step becomes the internal space 21 of the hollow metal member 1 to be finally obtained.

As described above, in the preparation step, the grooved metal member 46A having the groove portion 44A having various shapes can be prepared by casting, cutting, or the like. Therefore, by forming the groove portion 44A of the grooved metal member 46A in a desired shape, the hollow metal member 1 having the internal space 21 having a desired shape can be finally obtained. For example, the hollow metal member 1 having the internal space 21 extending in two directions of the X direction and the Z direction can be obtained from the grooved metal member 46A having the groove portion 44A with a depth longer (for example, twice, three times, . . . , 10 times, or more) than the probe length Q of the rotation tool 6.

The closing portion 3 is disposed to be offset outward with respect to the internal space 21. That is, the closing portion 3 is disposed to be offset to the side opposite to a center of the internal space 21 in the width direction (Y direction) with respect to the internal space 21. The closing portion 3 is disposed to be offset outward in the width direction (Y direction) with respect to an inner wall surface of the internal space 21 (an inner surface corresponding to the reference inner surface 51 described above). The closing portion 3 is formed to extend along the X direction, which is the extending direction of the internal space 21, at a position offset in the Y direction with respect to the internal space 21. When viewed from the Z direction, the closing portion 3 is formed in an elongated oval shape corresponding to a movement trace of the shoulder 61 of the rotation tool 6. The closing portion 3 is made of a metal material that is once softened by friction stirring in the closing step and then re-cured.

The closing portion 3 according to the embodiment is composed of, as a body, particles having crystal sizes smaller than that of a metal material constituting the body portion 2. An average particle diameter of the metal material constituting the body portion 2 is on the order of millimeters to submillimeters, whereas an average particle diameter of the metal material constituting the closing portion 3 is on the order of microns to subnanometers.

The closing portion 3 according to the embodiment has a dent portion 31 near one end portion of the internal space 21 in the X direction. The dent portion 31 has an inner surface shape corresponding to an outer shape of the probe 62 of the rotation tool 6. In the embodiment, the dent portion 31 has a columnar inner surface shape. The dent portion 31 is formed in a bottomed shape and does not communicate with the internal space 21. A depth of the dent portion 31 is equal to the probe length Q of the rotation tool 6.

The closing portion 3 according to the embodiment has a minute dent portion 32 linearly extending from the dent portion 31 along the X direction. The minute dent portion 32 is formed along a movement trace of the probe 62 of the rotation tool 6 when viewed from the Z direction. The minute dent portion 32 is formed in a shallow groove shape slightly dented in a recessed shape from an upper surface of the closing portion 3. A depth of the minute dent portion 32 is shallower than the depth of the dent portion 31 (shorter than the probe length Q of the rotation tool 6). In the embodiment, the depth of the minute dent portion 32 is shallower than half the depth of the dent portion 31, and in the shown example, is even shallower than ¼ of the depth of the dent portion 31.

### Second Embodiment

The hollow metal member 1 and a manufacturing method thereof (hollow metal member manufacturing method) according to a second embodiment will be described with reference to the drawings. In the embodiment, a specific configuration of the hollow metal member 1 is different from that of the first embodiment, and accordingly, a specific configuration of the recessed metal member 46 as a raw material is different from that of the first embodiment. Hereinafter, regarding the hollow metal member 1 and the manufacturing method of the same according to the embodiment, differences from the first embodiment will be mainly described. Points that are not particularly specified are the same as in the first embodiment and are denoted by the same reference numerals, and detailed description thereof is omitted.

The hollow metal member 1 according to the embodiment is a part of a case member 95 (see FIG. 9) that is used in, for example, a vehicle drive device and constitutes a rotary electric machine, a transmission mechanism, or the like therein. The case member 95 is formed in a lump shape using a metal material, and a flow path 96, through which a fluid such as lubricating oil or cooling water flows, is formed therein. The hollow metal member 1 is used as a member to be the source of the case member 95, and the flow path 96 is the internal space 21.

In the embodiment, the hollow metal member 1 is also manufactured using the friction stir processing (FSP). That is, in the hollow metal member manufacturing method according to the embodiment, the hollow metal member 1 is manufactured through a step of stirring a material softened by friction heat by plastic flow using the rotation tool 6 rotating at a high speed. The hollow metal member manufacturing method includes a step of preparing the recessed metal member 46 (preparation step) and a step of closing the recessed portion 44 formed in the recessed metal member 46 (closing step).

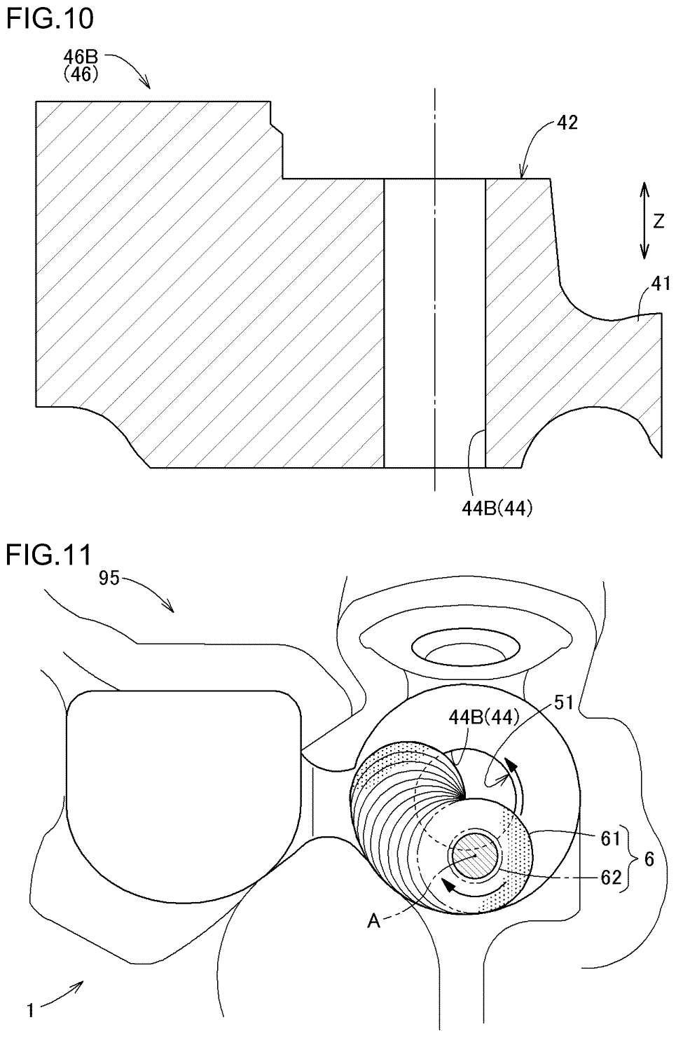

In the preparation step, the recessed metal member 46, in which the recessed portion 44 is formed from the surface to the inside of the metal member 41, is prepared. In the embodiment, in the preparation step, as shown in FIG. 10, a holed metal member 46B in which a hole portion 44B having a predetermined diameter and extending along a depth direction is formed from the surface to the inside of the metal member 41 is prepared. The holed metal member 46B as in the embodiment may be formed by performing drilling on the metal member 41 as a base body.

A shape of the hole portion 44B of the holed metal member 46B is determined according to the shape of the internal space 21 (flow path 96) of the hollow metal member 1 to be finally obtained. That is, the shape of the hole portion 44B is determined to include the shape of the desired internal space 21 (flow path 96) and to be a shape extending in one direction to open to the surface (opening surface 42) of the metal member 41. In the example shown in FIG. 10, the holed metal member 46B has a circular hole-shaped hole portion 44B extending in the Z direction until reaching the opening surface 42 while having the same shape as the desired internal space 21 (flow path 96). In this example, the Z direction is the depth direction of the hole portion 44B.

In the closing step, the hole portion 44B is closed by the friction stir processing (FSP) for the holed metal member 46B. The friction stir processing (FSP) is executed by using a friction stir device provided with the rotation tool 6 of the normal specification as in the first embodiment.

In the closing step, the rotation tool 6 is pressed against a position adjacent to the hole portion 44B of the opening surface 42 of the holed metal member 46B while being rotated at a high speed. In the embodiment, the rotation tool 6 is pressed against a position (offset position) of the opening surface 42 of the holed metal member 46B adjacent to the hole portion 44B in a radial direction of the hole portion 44B. Then, the metal material constituting the holed metal member 46B is locally heated and softened by the friction heat, and the probe 62 enters an inside of the holed metal member 46B. At this time, the probe 62 enters the inside of the holed metal member 46B until the lower surface of the shoulder 61 comes into contact with the opening surface 42 of the holed metal member 46B.

Next, while maintaining this state, as shown in FIG. 11, the rotation tool 6 is relatively moved along the position adjacent to the hole portion 44B of the opening surface 42 of the holed metal member 46B. That is, in a state where the probe 62 enters the inside of the holed metal member 46B until the lower surface of the shoulder 61 comes into contact with the opening surface 42, the rotation tool 6 is relatively moved along the position adjacent to the hole portion 44B of the opening surface 42 of the holed metal member 46B while being rotated at a high speed. In the embodiment, the rotation tool 6 is relatively moved along a trace parallel to an opening edge of the hole portion 44B at a position on the opening surface 42 of the holed metal member 46B on the outside of the opening edge of the hole portion 44B in the radial direction. Then, the metal material constituting the holed metal member 46B flows to the opening surface 42 side of the hole portion 44B while being sequentially softened by the friction heat, and the hole portion 44B is closed by the softened material.

As described above, in the closing step, the rotation tool 6 is moved (relatively moved) along a circular trace, which is concentric with the opening edge over an entire circumference of the hole portion 44B and has a large diameter, while being pressed against the opening surface 42 of the holed metal member 46B. In the closing step, the rotation tool 6 is moved in a circular shape along the opening edge over the entire circumference of the hole portion 44B. In the closing step, the hole portion 44B is closed by the softened material of the opening surface 42.

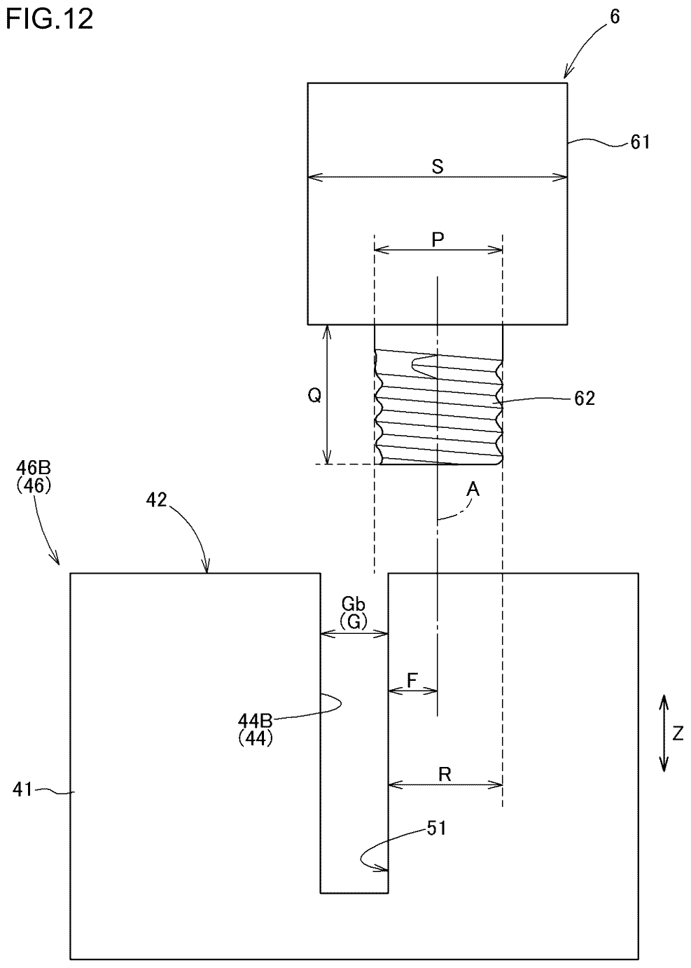

Referring to FIG. 12, the offset of the rotation tool 6 in the radial direction with respect to the hole portion 44B is preferably set to satisfy the following conditions. In the embodiment, an inner surface of the hole portion 44B is the reference inner surface 51 of the recessed portion 44.

The offset of the rotation tool 6 is preferably set such that the ratio (offset ratio (F/P)) of the offset width F, from the reference inner surface 51 of the recessed portion 44 (hole portion 44B) to the rotation axis A of the rotation tool 6, to the probe diameter P is 0 or more and 1 or less. The offset of the rotation tool 6 is preferably set such that the ratio of the processing margin R to the probe diameter P (processing margin ratio (R/P)) is 0.5 or more and 1.5 or less.

In the embodiment, it is sufficient that the hole portion 44B can be closed as a whole when the rotation tool 6 is rotated once along the circular trace concentric with the hole portion 44B. In this case, the offset width F is preferably set within a range in which the shoulder 61 of the rotation tool 6 covers a center of the hole portion 44B, and more quantitatively, is preferably set to be equal to or less than half the difference between the shoulder diameter S and the recessed portion width G (F≤0.5 (S−G)). In the embodiment, the recessed portion width G is a diameter of the hole portion 44B (hereinafter referred to as “hole diameter Gb”), and the offset width F is preferably set to be equal to or less than half a difference between the shoulder diameter S and the hole diameter Gb (F≤0.5 (S−Gb)).

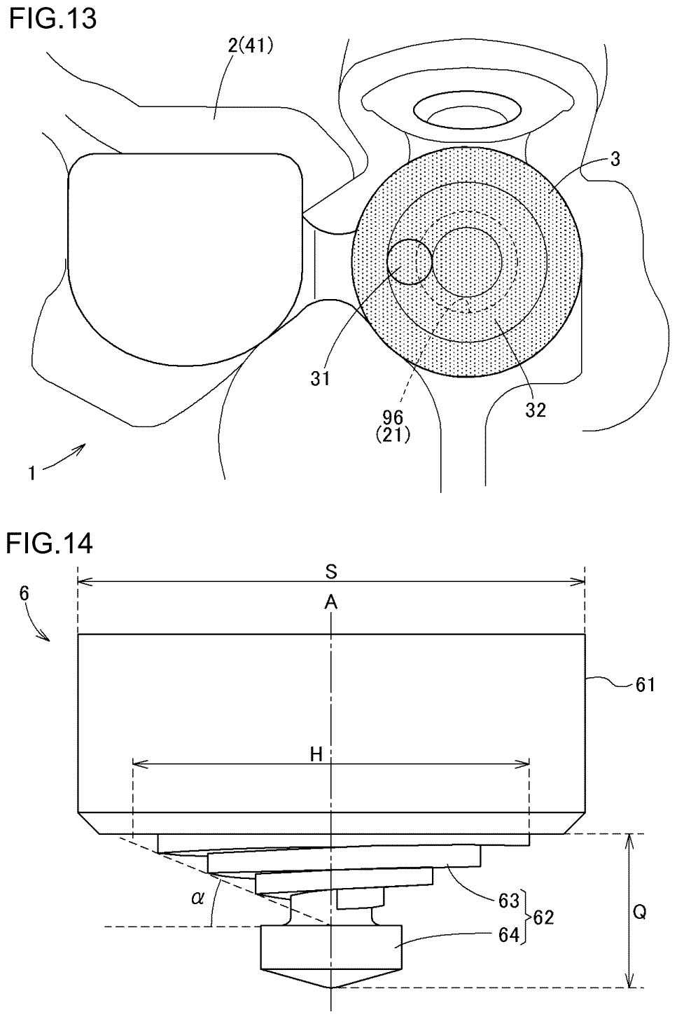

As shown in FIG. 13, the hollow metal member 1 obtained through these steps includes the body portion 2 in which the internal space 21 (flow path 96) is formed, and the closing portion 3 formed in the portion on the surface side of the body portion 2 with respect to the internal space 21 (flow path 96). The closing portion 3 is disposed to be offset outward with respect to the internal space 21 (flow path 96). That is, the closing portion 3 is disposed to be offset to the side opposite to the center of the internal space 21 (flow path 96) with respect to the internal space 21 (flow path 96). The closing portion 3 is disposed to be offset outward in the radial direction with respect to the inner wall surface (the inner surface corresponding to the reference inner surface 51 described above) of the internal space 21 (flow path 96). The closing portion 3 is formed to have a diameter larger than the internal space 21 (flow path 96), and is disposed concentrically with the internal space 21 (flow path 96). As described above, as an aspect, in the embodiment, even when the closing portion 3 is concentric as a whole, as long as the closing portion 3 is offset outward at each position in a circumferential direction, “the closing portion 3 is disposed to be offset outward with respect to the inner wall surface of the internal space 21”.

The closing portion 3 is made of a metal material that is once softened by friction stirring in the closing step and then re-cured. The closing portion 3 is composed of, as a body, particles having crystal sizes smaller than that of the metal material constituting the body portion 2.

The closing portion 3 according to the embodiment has the dent portion 31 at one position in the circumferential direction. The dent portion 31 has an inner surface shape corresponding to an outer shape of the probe 62 of the rotation tool 6. The dent portion 31 is formed in a bottomed shape and does not communicate with the internal space 21 (flow path 96). The closing portion 3 according to the embodiment has the minute dent portion 32 extending annularly from the dent portion 31 along the circumferential direction of the internal space 21 (flow path 96). The minute dent portion 32 is formed along the movement trace of the probe 62 of the rotation tool 6 when viewed from the Z direction. The minute dent portion 32 is formed in a shallow groove shape slightly dented in a recessed shape from an upper surface of the closing portion 3. The depth of the minute dent portion 32 is smaller than the depth of the dent portion 31.

### Third Embodiment

The hollow metal member 1 and a manufacturing method thereof (hollow metal member manufacturing method) according to a third embodiment will be described with reference to the drawings. In the embodiment, a specific configuration of the rotation tool 6 provided in the friction stir device used in the closing step is different from that of the first embodiment, and accordingly, a specific configuration of the hollow metal member 1 to be finally obtained is also different from that of the first embodiment. Hereinafter, regarding the hollow metal member 1 and the manufacturing method of the same according to the embodiment, differences from the first embodiment will be mainly described. Points that are not particularly specified are the same as in the first embodiment and are denoted by the same reference numerals, and detailed description thereof is omitted.

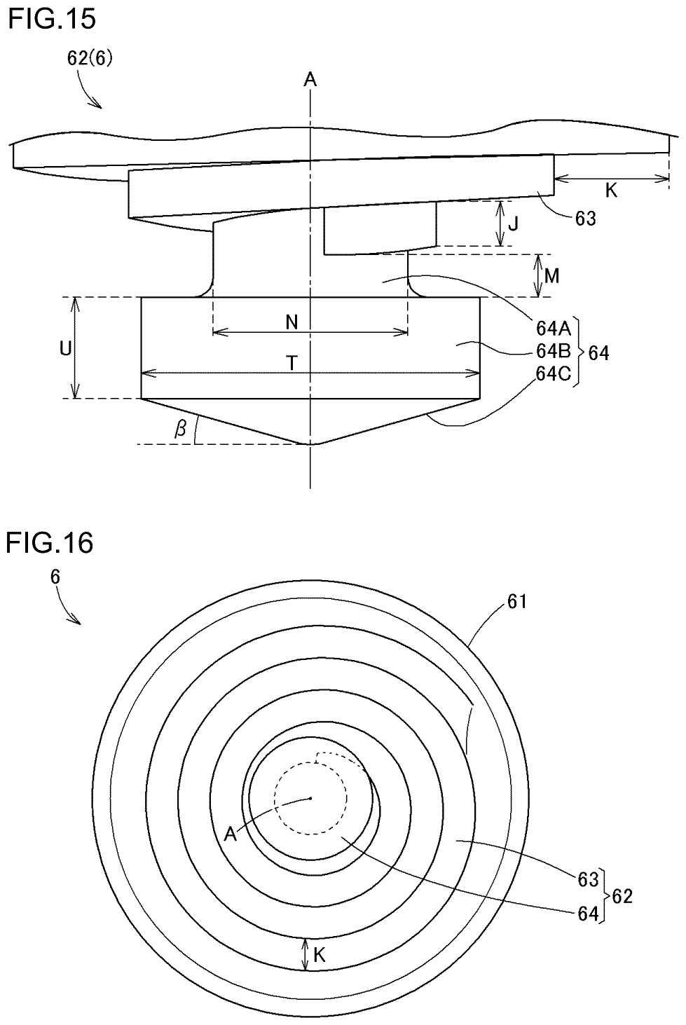

The rotation tool 6 used in the embodiment is similar to that of the first embodiment in that the rotation tool 6 includes the cylindrical shoulder 61 and the probe 62 coaxially integrated with the shoulder 61, but a specific configuration of the probe 62 is different from that of the first embodiment. As shown in FIGS. 14 to 16, the probe 62 according to the embodiment includes a spiral portion 63 continuous from the shoulder 61 and a receiving portion 64 provided at a tip end portion of the spiral portion 63. The receiving portion 64 includes a constricted portion 64A, a receiving body portion 64B, and a pointed portion 64C.

In FIGS. 14 to 16, a maximum diameter of the spiral portion 63 (hereinafter, referred to as “spiral diameter”) is denoted by “H”, a difference in height of one turn of the spiral portion 63 (hereinafter, referred to as “spiral pitch”) is denoted by “J”, and a difference in radius of one turn of the spiral portion 63 (hereinafter, referred to as “spiral width”) is denoted by “K”. A diameter of the constricted portion 64A (hereinafter referred to as “constricted diameter”) is denoted by “N”, and a length of the constricted portion 64A (the length between a lower end portion of the spiral portion 63 and the receiving body portion 64B, hereinafter referred to as “constricted length”) is denoted by “M”. A diameter of the receiving body portion 64B (hereinafter referred to as “receiving diameter”) is denoted by “T”, and a length of the receiving body portion 64B (hereinafter referred to as “receiving length”) is denoted by “U”. An angle formed by a horizontal plane and a virtual straight line connecting outermost points at respective positions of the spiral portion 63 (hereinafter referred to as “spiral angle”) is defined as “a”, and an angle formed by an outer surface of the pointed portion 64C and the horizontal plane (hereinafter referred to as “tip end angle”) is defined as “B”.

The spiral portion 63 is a portion that functions as an entity portion of the probe 62 (that is, a portion that frictionally stirs a material when the rotation tool 6 rotates at a high speed). In an axial direction of the shoulder 61, the spiral portion 63 is formed to draw a spiral while gradually decreasing in diameter as it goes away from the shoulder 61 (toward a tip end side of the probe 62). The spiral portion 63 is formed at a position slightly inside in the radial direction of an outer surface of the shoulder 61. The spiral diameter H is set to be smaller than the shoulder diameter S. A ratio (H/S) of the spiral diameter H to the shoulder diameter S is not particularly limited, and may be, for example, 0.7 or more and 0.95 or less, or may be 0.75 or more and 0.85 or less.

The spiral portion 63 is formed to draw a spiral with a substantially constant width. The spiral width K is set to a substantially constant value. A ratio (K/H) of the spiral width K to the spiral diameter H is not particularly limited, and may be, for example, 0.05 or more and 0.2 or less, or may be 0.1 or more and 0.15 or less.

The spiral portion 63 is formed to draw a spiral at a substantially constant pitch. The spiral pitch J is set to a substantially constant value. A ratio (J/K) of the spiral pitch J to the spiral width K is not particularly limited, and may be, for example, 0.2 or more and 0.8 or less, or may be 0.3 or more and 0.6 or less.

The spiral angle α is not particularly limited, and may be, for example, 22.5° or more and 60° or less, or may be 30° or more and 45° or less.

The receiving portion 64 is provided at the tip end portion of the spiral portion 63 to receive the material that has been frictionally stirred and softened by the spiral portion 63 from below. The receiving portion 64 includes the constricted portion 64A, the receiving body portion 64B, and the pointed portion 64C in this order from the shoulder 61 side (spiral portion 63 side) toward the tip end portion side.

The constricted portion 64A is a portion positioned in the middle of the probe 62 and formed to be thinner than other portions. The constricted portion 64A is formed slightly thinner than the lower end portion of the spiral portion 63. The constricted diameter N is not particularly limited, and may be, for example, 3 mm or more and 6 mm or less, or may be 4 mm or more and 5 mm or less. The constricted length M is not particularly limited, and may be, for example, 0.5 mm or more and 2.5 mm or less, or may be 0.8 mm or more and 1.8 mm or less.

A ratio (N/H) of the constricted diameter N to the spiral diameter H is not particularly limited, and may be, for example, 0.1 or more and 0.3 or less, or may be 0.15 or more and 0.25 or less. A ratio (M/Q) of the constricted length M to the probe length Q is not particularly limited, and may be, for example, 0.05 or more and 0.2 or less, or may be 0.08 or more and 0.15 or less. A ratio (M/N) of the constricted length M to the constricted diameter N is not particularly limited, and may be, for example, 0.1 or more and 0.25 or less, or may be 0.15 or more and 0.2 or less.

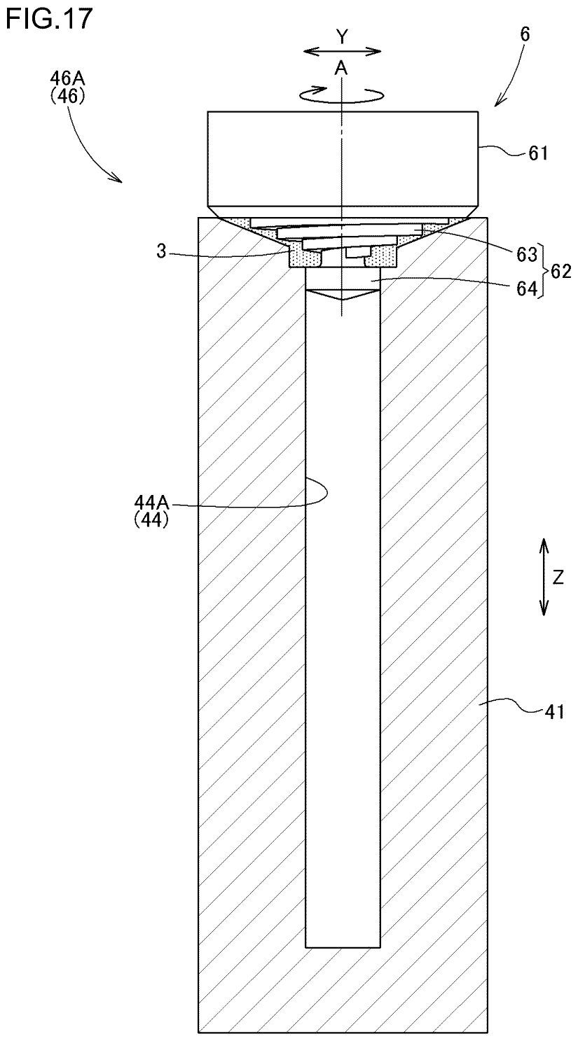

The receiving body portion 64B is a portion that functions as an entity portion of the receiving portion 64 (that is, a portion that receives the softened material from below). The receiving body portion 64B is formed in a flat columnar shape. A receiving diameter T is not particularly limited, and is preferably equal to (see FIG. 17) or slightly smaller than the recessed portion width G of the recessed portion 44 of the recessed metal member 46 (in the embodiment, the groove width Ga of the groove portion 44A of the grooved metal member 46A). A ratio (U/Q) of the receiving length U to the probe length Q is not particularly limited, and may be, for example, 0.2 or more and 0.4 or less, or may be 0.25 or more and 0.3 or less. A ratio (U/T) of the receiving length U to the receiving diameter T is not particularly limited, and may be, for example, 0.1 or more and 0.5 or less, or may be 0.2 or more and 0.4 or less.

The pointed portion 64C is a pointed portion on a tip end side of the receiving portion 64. The pointed portion 64C is formed in a flat inverted conical shape to gradually decrease in diameter toward the tip end side (away from the receiving body portion 64B). The pointed portion 64C functions as a guide portion that performs center alignment when a center of the rotation tool 6 deviates from a center of the recessed portion 44 (the groove portion 44A in the embodiment) in the Y direction. The tip end angle β is not particularly limited, and may be, for example, equal to or less than the spiral angle α. The tip end angle β may be, for example, 7.5° or more and 30° or less, or may be 10° or more and 20° or less.

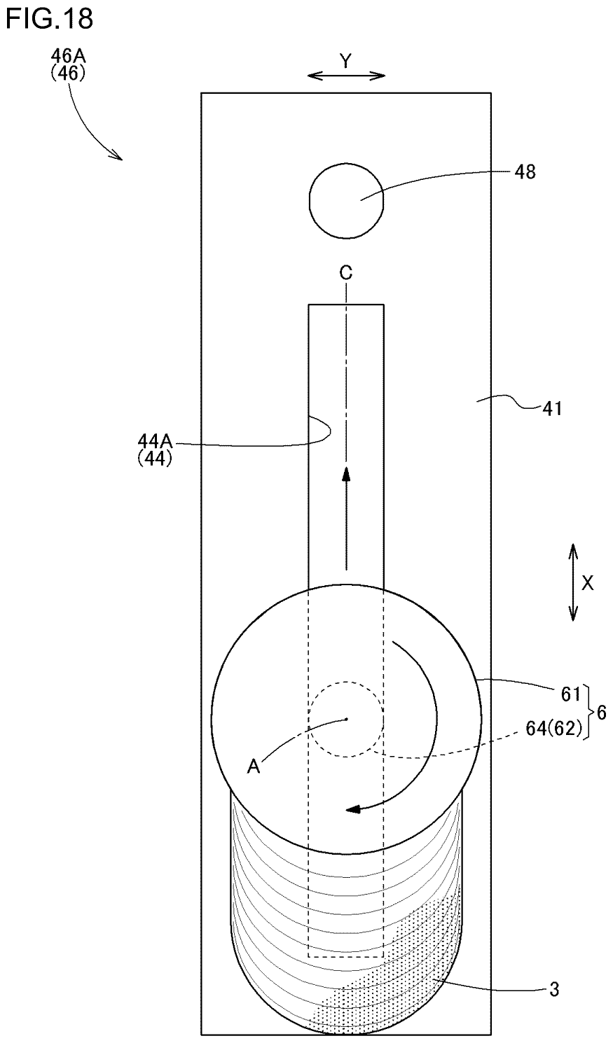

In the embodiment, in the closing step, as shown in FIGS. 17 and 18, the rotation tool 6 is relatively moved along a center line C of the opening of the recessed portion 44 (groove portion 44A) using the friction stir device including the rotation tool 6 having a special specification described above. That is, the rotation tool 6 is relatively moved along the center line C of the opening of the recessed portion 44 (groove portion 44A) while being rotated at a high speed in a state where the receiving portion 64 enters the recessed portion 44 (groove portion 44A) and the spiral portion 63 is in contact with an upper surface of the recessed metal member 46 (grooved metal member 46A). Then, while the metal material constituting the grooved metal member 46A is sequentially softened by the friction heat and flows to the opening surface 42 side of the groove portion 44A, the metal material is received from below by the receiving portion 64, and the groove portion 44A is closed by the softened material.

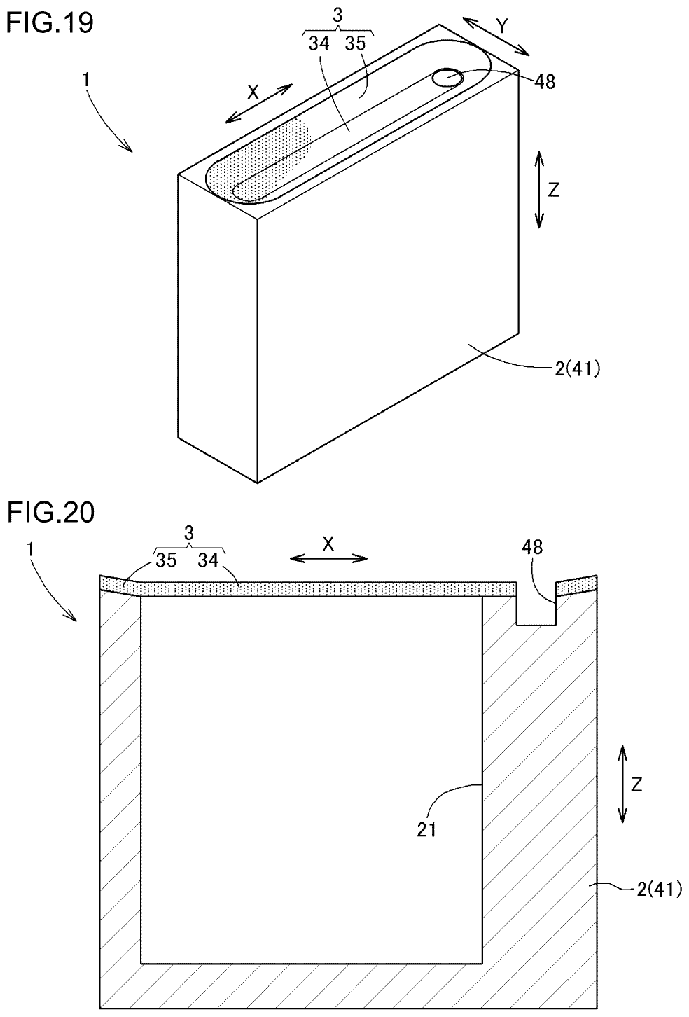

In the embodiment, as shown in FIGS. 19 and 20, an escape hole 48 is formed at a position adjacent to an end portion in the X direction of the recessed portion 44 (groove portion 44A) in the recessed metal member 46 (grooved metal member 46A). In the shown example, the escape hole 48 is provided at a position further adjacent to the end portion in the X direction of the recessed portion 44 (groove portion 44A) in the X direction, but may be deviated in the Y direction when there is a space in the Y direction. An inner diameter and a depth of the escape hole 48 are set not to interfere with the probe 62 (particularly, the receiving portion 64) of the rotation tool 6.

In the embodiment, since the rotation tool 6 includes the receiving portion 64, when the rotation tool 6 is raised and pulled out from the recessed metal member 46 (grooved metal member 46A) in a final aspect of the closing step, a recessed hole corresponding to an outer shape of the receiving portion 64 is inevitably formed. Even in such a case, by moving the rotation tool 6 to the position of the escape hole 48 and then pulling out the rotation tool 6 in the final aspect of the closing step, it is possible to prevent the internal space 21 of the finally obtained hollow metal member 1 from unintentionally communicating with the outside due to the inevitably generated recessed hole.

As shown in FIGS. 19 and 20, the hollow metal member 1 obtained in the embodiment includes the body portion 2 in which the internal space 21 is formed, and the closing portion 3 formed in the portion on the surface side of the body portion 2 with respect to the internal space 21. The origin of the body portion 2 and the origin of the internal space 21 are the same as those in the first embodiment. Similarly to the first embodiment, the closing portion 3 is composed of, as a body, particles having crystal sizes smaller than that of the metal material constituting the body portion 2.

In the embodiment, the closing portion 3 has a bottom surface 34 and a tapered surface 35. The bottom surface 34 is formed in a shape corresponding to the recessed portion 44 (groove portion 44A) of the recessed metal member 46 (grooved metal member 46A). The bottom surface 34 is provided at a position slightly lower than an upper surface of the hollow metal member 1. The tapered surface 35 is inclined gradually upward from the bottom surface 34 toward the outside. The tapered surfaces 35 inclined upward toward the outside are provided on both sides in the Y direction with the center line C of the internal space 21 interposed therebetween, and on both sides in the X direction of the internal space 21. The tapered surface 35 is formed around the bottom surface 34 to surround an entire circumference of the bottom surface 34.

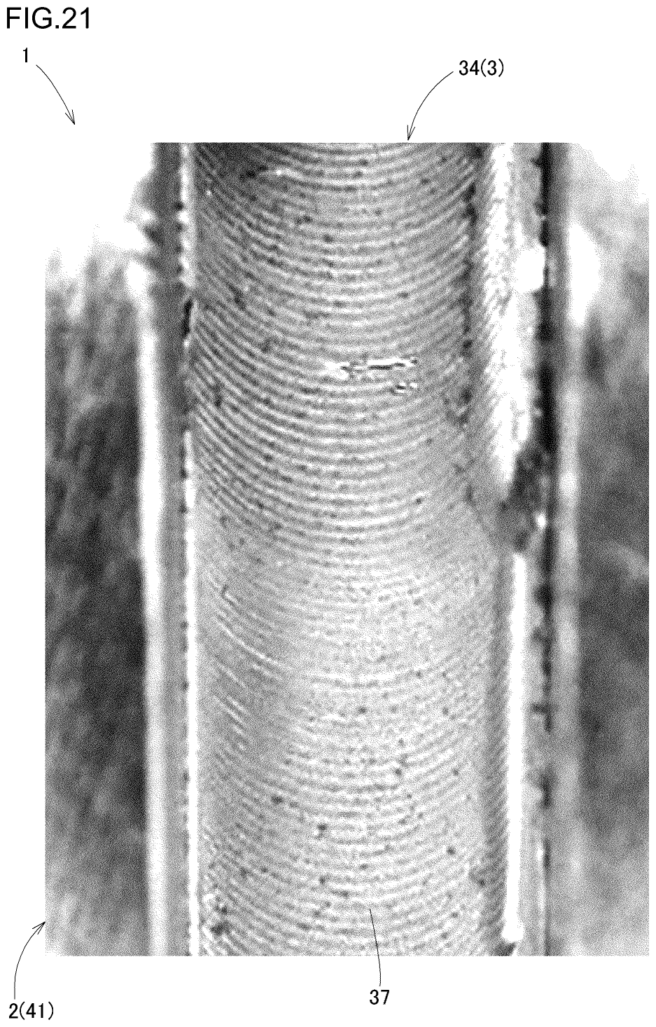

In the embodiment, as shown in FIG. 21, the closing portion 3 has a tool trace 37 on a back surface (that is, a surface facing the internal space 21). The tool trace 37 is a trace generated when the rotation tool 6 moves while rotating, and more specifically, a trace generated on a back surface of the bottom surface 34 when the receiving portion 64 moves while rotating. In the embodiment, the tool trace 37 is a trace formed by connecting a plurality of arc-shaped curves at substantially equal intervals in the X direction. As described above, one of the features of the hollow metal member 1 according to the embodiment is that the tool trace 37 generated by the rotation and movement of the rotation tool 6 can be confirmed when the closing portion 3 is viewed from the internal space 21 side.

### Other Embodiments

(1) In each of the above embodiments, a configuration, in which the recessed portion 44 (groove portion 44A/hole portion 44B) of the recessed metal member 46 is open only on a single surface, has been described as an example. However, the disclosure is not limited to such a configuration, and the recessed portion 44 of the recessed metal member 46 may be open to a plurality of surfaces. In this case, in the closing step, the friction stir processing (FSP) is performed for each of a plurality of opening surfaces 42 to close the recessed portion 44 by cooperation of a plurality of closing portions 3.

(2) In each of the above embodiments, a configuration, in which the cooling member 90 and the case member 95 using the hollow metal member 1 are independent members, has been mainly assumed and described. However, the disclosure is not limited to such a configuration, and the cooling member 90 and the case member 95 using the hollow metal member 1 may be integrated. Alternatively, one or both of the cooling member 90 and the case member 95 may be integrated with another member.

(3) In each of the above embodiments, a configuration, in which the recessed portion 44 formed in the recessed metal member 46 is the groove portion 44A extending along the longitudinal direction or the hole portion 44B extending along the depth direction, has been described as an example. However, the recessed portion 44 is not limited to such a configuration, and may be formed in a more complicated shape such as an L shape, a T shape, a crank shape, or a meandering shape.

(4) The configurations disclosed in the above embodiments (including the above embodiments and other embodiments, the same applies hereinafter) can be applied in combination with configurations disclosed in other embodiments as long as no contradiction occurs. In regard to other configurations, the embodiments disclosed in the present specification are shown in all respects, and can be appropriately modified without departing from the gist of the disclosure.

### Overview of Embodiments

In summary, a hollow metal member manufacturing method according to the disclosure preferably includes the following configurations.

The hollow metal member manufacturing method for manufacturing a hollow metal member (1), which is a metal member (41) having an internal space (21), by using a rotation tool (6), the method includes:
a step of preparing a recessed metal member (46) in which a recessed portion (44) corresponding to a desired internal space shape is formed from a surface to an inside of the metal member (41); and
a step of moving the rotation tool (6) along an opening of the recessed portion (44) while pressing the rotation tool (6) against an opening surface (42), which is a surface of the recessed metal member (46) on which the recessed portion (44) is formed, and closing the recessed portion (44) with a softened material of the opening surface (42).

According to this configuration, the rotation tool (6) is moved along the opening of the recessed portion (44) while the rotation tool (6) is pressed against the opening surface (42) of the recessed metal member (46) in which the recessed portion (44) having a shape corresponding to the desired internal space shape is formed from the surface to the inside of the metal member (41) regardless of a shape of the rotation tool (6). Thus, the recessed portion (44) can be closed by the softened material using a friction stir processing (FSP). Therefore, the hollow metal member (1) can be formed while securing a degree of freedom of a shape of the internal space (21).

As an aspect, it is preferable that
in the step of closing the recessed portion (44), the rotation tool (6) is moved along an opening edge of the recessed portion (44).

According to this configuration, the opening of the recessed portion (44) is easily closed by the material softened in the friction stir processing (FSP). Therefore, the hollow metal member (1) in which the degree of freedom of the shape of the internal space (21) is secured can be appropriately formed by using the rotation tool (6) of the normal specification generally used for the friction stir processing (FSP).

As an aspect, it is preferable that
in the step of closing the recessed portion (44), the rotation tool is moved in a range in which a ratio of an offset width (F), along the opening surface (42) from a reference inner surface (51) of the recessed portion (44) to a rotation axis (A) of the rotation tool (6), to a diameter (P) of a probe (62) of the rotation tool (6) is 0 or more and 1 or less.

By setting the ratio (hereinafter, referred to as “offset ratio”) of the offset width (F), from the reference inner surface (51) of the recessed portion (44) to the rotation axis (A) of the rotation tool (6), to the probe diameter (P) of the rotation tool (6) to 0 or more, an amount of the material softened by the friction stir processing (FSP) can be sufficiently secured. By setting the offset ratio to 1 or less, it is possible to secure that the material softened by the friction stir processing (FSP) flows to the opening surface (42) of the recessed portion (44). Therefore, according to this configuration, the opening surface (42) of the recessed portion (44) can be appropriately closed by the softened material using the friction stir processing (FSP).

As an aspect, it is preferable that
the recessed portion (44) is a groove portion (44A) extending along a longitudinal direction (X), and
the offset width (F) is set within a range in which a shoulder (61) of the rotation tool (6) covers an inner surface (52) of the groove portion (44A) opposite to the reference inner surface (51).

According to this configuration, the opening surface (42) of the groove portion (44A) can be closed by one process performed along a position adjacent to the groove portion (44A) formed in the recessed metal member (46). Therefore, the hollow metal member (1) can be efficiently formed.

As an aspect, it is preferable that
the recessed portion (44) is a groove portion (44A) extending along a longitudinal direction (X), and
in the step of closing the recessed portion (44), the rotation tool (6) is linearly moved along at least one of opening edges of the groove portion (44A) along the longitudinal direction (X).

According to this configuration, when the recessed portion (44) is the groove portion (44A) extending along the longitudinal direction (X), the groove portion (44A) can be appropriately closed in the step of closing the recessed portion (44).

As an aspect, it is preferable that
the recessed portion (44) is a hole portion (44B) extending along a depth direction (Z), and
in the step of closing the recessed portion (44), the rotation tool (6) is moved in a circular shape along an opening edge over an entire circumference of the hole portion (44B).

According to this configuration, when the recessed portion (44) is the hole portion (44B) extending along the depth direction (Z), the hole portion (44B) can be appropriately closed in the step of closing the recessed portion (44).

As an aspect, it is preferable that
in the step of closing the recessed portion (44), the rotation tool (6) is moved along a center line (C) of the opening of the recessed portion (44).

According to this configuration, even when a sufficient thickness is not secured at one position adjacent to the recessed portion (44) in the metal member (41), the opening of the recessed portion (44) can be closed by the material softened in the friction stir processing (FSP) by using the rotation tool (6) of a special specification. Therefore, it is possible to appropriately form the hollow metal member (1) in which the internal space (21) having a degree of freedom in shape is formed in a well-balanced manner in a width direction (Y).

The present specification also discloses a product (hollow metal member (1)) manufactured by the above-described hollow metal member manufacturing method. Such a hollow metal member (1) preferably has the following configuration.

The hollow metal member (1) having an internal space (21) includes:
a body portion (2) in which the internal space (21) having a desired shape is formed; and
a closing portion (3) formed along the internal space (21) in a portion on a surface side of the body portion (2) with respect to the internal space (21), the closing portion (3) being mainly composed of particles having crystal sizes smaller than a constituent material of the body portion (2), in which
the closing portion (3) is disposed to be offset outward with respect to an inner wall surface of the internal space (21).

According to this configuration, the closing portion (3) can be provided in a portion of the body portion (2) closer to the surface side than the internal space (21) by using the friction stir processing (FSP). Since the step of forming a space to be the source of the internal space (21) in the metal member and the step of forming the closing portion (3) can be separated, the internal space (21) can be formed while securing the degree of freedom in shape. In addition, by disposing the closing portion (3) to be offset outward with respect to the inner wall surface of the internal space (21), when the closing portion (3) is provided using the friction stir processing (FSP), a portion on the surface side with respect to the internal space (21) can be appropriately closed. Therefore, the hollow metal member (1) has the internal space (21) having the desired shape.

A tool (rotation tool (6)) of a special specification used for manufacturing the above-described hollow metal member (1) is also disclosed in the present specification. Such a rotation tool (6) preferably has the following configuration.

The rotation tool (6) for manufacturing a hollow metal member (1) that is a metal member (41) having an internal space (21), the rotation tool (6) includes:
a cylindrical shoulder (61); and
a probe (62) coaxially integrated with the shoulder (61), in which
the probe (62) includes a spiral portion (63) having a diameter that decreases as is away from the shoulder (61) in an axial direction of the shoulder (61), and a receiving portion (64) provided at a tip end portion of the spiral portion (63) to receive a material stirred and softened by the spiral portion (63) from below.

According to this configuration, the material is frictionally stirred by the spiral portion (63) of the probe (62), and the softened material can be made to flow near the opening of the recessed portion (44). Since the probe (62) has the receiving portion (64) at the tip end portion of the spiral portion (63), the softened material is received from below by the receiving portion (64) and does not flow into the recessed portion (44). Therefore, it is possible to close the recessed portion (44) while moving the rotation tool (6) along the center line (C) of the opening of the recessed portion (44). Therefore, by using the rotation tool (6) having this configuration, it is possible to appropriately manufacture the hollow metal member (1) in which the internal space (21) having a degree of freedom in shape is formed in a well-balanced manner in the width direction (Y).

The hollow metal member (1) formed using the rotation tool (6) of the special specification described above is a hollow metal member (1) having an internal space (21), and includes:
a body portion (2) in which the internal space (21) having a desired shape is formed; and
a closing portion (3) formed along the internal space (21) in a portion on a surface side of the body portion (2) with respect to the internal space (21), the closing portion (3) being mainly composed of particles having crystal sizes smaller than a constituent material of the body portion (2), in which
the closing portion (3) has tapered surfaces (35) inclined upward toward an outer side on both sides in a width direction (Y) across a center line (C) of the internal space (21).

Another hollow metal member (1) formed using the rotation tool (6) of the special specification described above is a hollow metal member (1) having an internal space (21), and includes:
a body portion (2) in which the internal space (21) having a desired shape is formed; and
a closing portion (3) formed along the internal space (21) in a portion on a surface side of the body portion (2) with respect to the internal space (21), the closing portion (3) being mainly composed of particles having crystal sizes smaller than a constituent material of the body portion (2), in which
the closing portion (3) has a tool trace (37) generated by the rotation tool (6) moving while rotating on a back surface facing the internal space (21).

The hollow metal member manufacturing method, the hollow metal member, and the rotation tool according to the disclosure may exhibit at least one of the above-described effects.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A hollow metal member manufacturing method for manufacturing a hollow metal member, which is a metal member having an internal space, by using a rotation tool, the method comprising:
a step of preparing a recessed metal member in which a recessed portion corresponding to a desired internal space shape is formed from a surface to an inside of the metal member; and
a step of moving the rotation tool along an opening of the recessed portion while pressing the rotation tool against an opening surface, which is a surface of the recessed metal member on which the recessed portion is formed, and closing the recessed portion with a softened material of the opening surface.

2. The hollow metal member manufacturing method according to claim 1, wherein
in the step of closing the recessed portion, the rotation tool is moved along an opening edge of the recessed portion.

3. The hollow metal member manufacturing method according to claim 2, wherein
in the step of closing the recessed portion, the rotation tool is moved in a range in which a ratio of an offset width, along the opening surface from a reference inner surface of the recessed portion to a rotation axis of the rotation tool, to a diameter of a probe of the rotation tool is 0 or more and 1 or less.

4. The hollow metal member manufacturing method according to claim 2, wherein
the recessed portion is a groove portion extending along a longitudinal direction, and
in the step of closing the recessed portion, the rotation tool is linearly moved along at least one of opening edges of the groove portion along the longitudinal direction.

5. The hollow metal member manufacturing method according to claim 3, wherein
the recessed portion is a groove portion extending along a longitudinal direction, and
in the step of closing the recessed portion, the rotation tool is linearly moved along at least one of opening edges of the groove portion along the longitudinal direction.

6. The hollow metal member manufacturing method according to claim 2, wherein
the recessed portion is a hole portion extending along a depth direction, and
in the step of closing the recessed portion, the rotation tool is moved in a circular shape along an opening edge over an entire circumference of the hole portion.

7. The hollow metal member manufacturing method according to claim 3, wherein
the recessed portion is a hole portion extending along a depth direction, and
in the step of closing the recessed portion, the rotation tool is moved in a circular shape along an opening edge over an entire circumference of the hole portion.

8. The hollow metal member manufacturing method according to claim 1, wherein
in the step of closing the recessed portion, the rotation tool is moved along a center line of the opening of the recessed portion.

9. A hollow metal member having an internal space, the hollow metal member comprising:
a body portion in which the internal space having a desired shape is formed; and
a closing portion formed along the internal space in a portion on a surface side of the body portion with respect to the internal space, the closing portion being mainly composed of particles having crystal sizes smaller than a constituent material of the body portion, wherein
the closing portion is disposed to be offset outward with respect to an inner wall surface of the internal space.

10. A hollow metal member having an internal space, the hollow metal member comprising:
a body portion in which the internal space having a desired shape is formed; and
a closing portion formed along the internal space in a portion on a surface side of the body portion with respect to the internal space, the closing portion being mainly composed of particles having crystal sizes smaller than a constituent material of the body portion, wherein
the closing portion has tapered surfaces inclined upward toward an outer side on both sides in a width direction across a center line of the internal space.

11. A hollow metal member having an internal space, the hollow metal member comprising:
a body portion in which the internal space having a desired shape is formed; and
a closing portion formed along the internal space in a portion on a surface side of the body portion with respect to the internal space, the closing portion being mainly composed of particles having crystal sizes smaller than a constituent material of the body portion, wherein
the closing portion has a tool trace generated by the rotation tool moving while rotating on a back surface facing the internal space.

12. A rotation tool for manufacturing a hollow metal member that is a metal member having an internal space, the rotation tool comprising:
a cylindrical shoulder; and
a probe coaxially integrated with the shoulder, wherein
the probe includes a spiral portion having a diameter that decreases as is away from the shoulder in an axial direction of the shoulder, and a receiving portion provided at a tip end portion of the spiral portion to receive a material stirred and softened by the spiral portion from below.
